(19) United States
(12) Patent Application Publication
(10) Pub. No.: US 2011/0310003 A1
(43) Pub. Date: Dec. 22, 2011

(54) IMAGE DISPLAY DEVICE AND METHOD OF DISPLAYING IMAGES

(75) Inventor: René de la Barré, Mittweida (DE)

(73) Assignee: Fraunhofer-Gesellschaft zur Forderung der angewandten Forschung e.V., Munchen (DE)

(21) Appl. No.: 13/113,705

(22) Filed: May 23, 2011

Related U.S. Application Data
(60) Provisional application No. 61/346,947, filed on May 21, 2010.

(51) Int. Cl. G06F 3/01

(52) U.S. Cl. 345/156

(57) ABSTRACT

An image display device includes an autostereoscopic screen for simultaneously displaying a plurality of different images which are visible from in each case at least one of different laterally offset viewing zones and a control unit for controlling the screen in dependence on image information of the different images, wherein the screen has a matrix screen with a plurality of pixels arranged in columns and rows as well as a grating arranged in front of the matrix screen and having a structure orientated parallel to the columns to direct light emanating from the pixels of the matrix screen into the different viewing zones. The image display device furthermore has a tracking device for detecting two respective eye positions of at least two viewers of the screen, wherein the control unit is configured for inputting input commands.

### RELATED APPLICATION

This application claims the benefit of U.S. Provisional Application Ser. No. 61/346,947 filed May 21, 2010 entitled “Image Display Device and Method of Displaying Images”, which application is incorporated by reference herein in its entirety.

### TECHNICAL FIELD

The invention relates to an image display device as well as to a method of displaying images that can be carried out using an image display device of the proposed kind.

### BACKGROUND

A generic image display device includes an autostereoscopic screen for the simultaneous display of more than two different images which are visible from in each case at least one of different laterally offset viewing zones and a control unit for controlling the screen in dependence on image information of the different images, wherein the screen has a matrix screen with a plurality of pixels arranged in columns and rows as well as a grating arranged in front of the matrix screen and having a structure orientated parallel to the columns to direct light emanating from the pixels of the matrix screen into the different viewing zones. Such image display devices are known per se as multiview displays.

To operate such an image display device in the conventional manner, image information of a whole family of stereoscopic half-images which are complementary pair-wise is required. In this respect, the displayed images can admittedly also be viewed by a plurality of viewers simultaneously, but it is not possible to take individual desires of the different viewers into account either in the selection of the image contents to be presented or in the kind of display. The latter can in particular be disadvantageous because not everyone is able to assemble stereoscopic images without problem from different stereoscopic half-images and also to perceive them as such without complaints over a longer period.

### SUMMARY

In some embodiments, the invention pertains to an image display device with which different viewers can be shown images simultaneously, wherein the viewers should be able to select both image contents—defined e.g. by different television channels or video channels—and a type of display according to their own wishes. In some embodiments, the invention pertains to a corresponding method with which different viewers of a screen can be presented with different contents in a manner individually selectable for each viewer.

In some embodiments, the image display device therefore has, in addition to the features already named, a tracking device for detecting two respective eye positions of at least two viewers of the screen. In this respect, the control device is configured for inputting input commands which define in each case one of different possible image contents and one of different selectable display modes for at least two different viewers independently, wherein the selectable display modes include a monoscopic image mode and an individual stereoscopic image mode. In addition, the control unit is configured to control the screen in dependence on these input commands and on the eye positions detected by the tracking device in that different disjunctive excerpts of columns of the matrix screen are defined and in each case at least one of different images is reproduced on each of the excerpts, and indeed such that one of the excerpts is associated with each of the detected eye positions of each viewer, said one excerpt including at least all columns of the matrix screen visible through the grating from this eye position. In this respect, the control unit is configured to control the pixels of this excerpt so that the at least one image displayed on this excerpt shows the image content defined for this viewer, wherein the same excerpt is associated with the two eye positions of each viewer for whom the monoscopic mode is selected as the display mode and the image displayed on said excerpt is a monoscopic image, whereas two different excerpts are associated with the two eye positions of every viewer for whom the individual stereoscopic image mode is selected as the display mode and two mutually complementary stereoscopic half-images are displayed on these excerpts.

Two things are thereby advantageously achieved. First, different viewers who want to have different image contents displayed to them—e.g. different television channels or video channels or image contents defined by video games—can use the same screen simultaneously and can in particular be in the same room, that is, they are not dependent on using different devices. Second, it can be avoided by the display mode individually selectable for each viewer that in this respect one of the viewers is forced to be satisfied with a less detailed representation, e.g. mono instead of stereo—or a representation less pleasing for him—e.g. stereo instead of mono. In particular individual vision habits can thus be taken into account. In this respect, the individual desires can be realized in an advantageously simple manner by corresponding input commands.

In some embodiments, the control unit for inputting the input commands may include one or more operating devices separate from a central processing unit of the control unit which can be connected to the central processing unit via cable connections or wireless data transfer. In the case of a plurality of operating devices, each of the viewers can thus input the input commands relevant to him in an advantageous manner at an operating device associated with him alone.

The pixels of the matrix screen may be subpixels of three different basic colors which combine to form one picture element. In this respect, different arrangements are conceivable, wherein the basic colors naturally alternate, in some embodiments, in every column from top to bottom and typically also in every row from left to right in a cyclic order.

In some embodiments, the different excerpts are formed by different columns of the matrix screen which are disposed next to one another and which can accordingly be controlled simultaneously. However, the possibility of a screen in which the excerpts are controlled sequentially in time and are formed in each case by the same pixels at different times while the grating is changeable over time should also explicitly not be excluded. An excerpt is then not only defined by the pixels included therein, but rather also by the position or the condition of the grating. Such a screen is e.g. shown in the document WO 2009/001161 A1.

In some embodiments, the selectable display modes further include a multiview stereoscopic image mode, wherein the control unit is then configured to control the screen so that the same excerpt is associated with the two eye positions of each viewer for whom the multiview stereoscopic image mode is selected as the display mode by a corresponding input command and a respective one of a family of complementary stereoscopic half-images is displayed on different subsets of columns of this excerpt. If a plurality of viewers select the same image content and this multiview stereoscopic image mode, the excerpt can naturally also be selected to be so large that it includes all columns which are visible from at least one of the eye positions of any one of these viewers. The screen then works as a conventional multiview display for these viewers.

In this case the control unit can include a renderer which is configured to calculate control data for the matrix screen required for the representation of the family of stereoscopic half-images from image information on the image content which is defined by the input commands for the viewer for whom the multiview stereoscopic image mode is selected as the display mode. In some embodiments, this can be provided when the image content is defined by a video game.

In some embodiments, and so that the viewer can move within boundaries which are as wide as possible without having to accept losses in the image quality or having to fully lose sight of the respective image, the tracking device may be configured to detect a movement of the eye positions, while the control unit is configured to redefine the excerpts in dependence on the detected movement. For this purpose, the tracking device can in some cases be realized by a stereoscopic camera having a corresponding image evaluation.

In some embodiments, it is useful if the control unit is configured to accept the input commands for the at least two viewers successively as registrations of the viewers. The control unit can moreover have an output unit to be able to display information on the available image contents and/or on the display modes selectable for the respective image content and/or on whether a last input command can be executed. This output unit can e.g. be realized by a display. In this case, the control unit can in particular be configured by a corresponding programming to determine and to display on the display unit in dependence on already inputted input commands and on the detected eye positions whether a further viewer can be registered and/or whether or how a positioning of already registered viewers has to be changed so that a further viewer can be registered or a last inputted input command can be executed.

In some embodiments, an advantageous process of displaying images can be carried out using an image display unit described herein, the process including steps of:

inputting input commands into a control unit which define in each case one of different possible image contents and one of different selectable display modes for at least two different viewers independently, wherein the selectable display modes include a monoscopic image mode and a stereoscopic image mode;

detecting a respective two eye positions of at least two viewers; and

controlling a matrix screen having a plurality of pixels arranged in different columns, the matrix screen controlled by the control unit in dependence on the input commands and on the eye positions detected by the tracking device as well as in dependence on image information of different images defined by the image contents so that the images are displayed simultaneously on different subgroups of pixels of the matrix screen, wherein light emanating from the pixels is directed by a grating arranged in front of the matrix screen into different laterally offset regions from which one of the respective images is visible.

In some embodiments, this is done so that different disjunctive excerpts of columns of the matrix screen are defined by the control unit and in each case at least one of the different images is displayed on each of the excerpts, and indeed such that one of the excerpts is associated with each of the detected eye positions of each viewer, said one excerpt including at least all columns of the matrix screen visible from this eye position through the grating, wherein the pixels of this excerpt are controlled so that the at least one image displayed on this excerpt shows the image content defined for this viewer; wherein the same excerpt is associated with the two eye positions of each viewer for whom the monoscopic image mode is selected as the display mode and a monoscopic image is displayed on this excerpt, whereas two different excerpts are associated with the two eye positions of each viewer for whom the individual stereoscopic image mode is selected as the display mode and two mutually complementary stereoscopic half-images are displayed on these excerpts.

If the selectable display modes moreover include a multiview stereoscopic image mode, the matrix screen can be controlled in the process so that in each case the same excerpt is associated with the two eye positions of each viewer for whom the multiview stereoscopic image mode is selected as the display mode and a respective one from a whole family of complementary stereoscopic half-images is displayed on different subgroups of columns of this excerpt.

In some embodiments, the image display device may be able to recognize the viewers—e.g. by an image evaluation of images taken by the tracking device—and, on recognition of a viewer, automatically selects a setting (e.g. a display mode) which is preset for this viewer. The control unit can also be configured to correct a depth of field presented to the viewer in accordance with a default of this viewer.

Parts of the matrix screen not covered by the named excerpts can finally be filled with suitable image content in order also to allow persons standing by to be able to follow at least the one or the other image content.

The different excerpts will form a respective family of strips including one or more columns on the matrix screen, wherein the strips belonging to the different excerpts typically alternate in a cyclic order. If an excerpt is in turn broken down into different subsets or subgroups of columns in order to realize the multiview stereoscopic mode in the previously described manner, the subsets or subgroups typically respectively comprise a column in each of the strips belonging to this excerpt.

### BRIEF DESCRIPTION OF THE FIGURES

An embodiment of the invention will be explained in the following with reference to FIGS. 1 to 3.

FIG. 1 is a plan view of a schematic representation of an image display device with which image information for three different viewers are presented simultaneously;

FIG. 2 is a block diagram which illustrates an operation of a control unit of the image display device of FIG. 1; and

FIG. 3 is a flowchart to illustrate a function of an interactive operating device of the control unit of the image display device.

### DETAILED DESCRIPTION

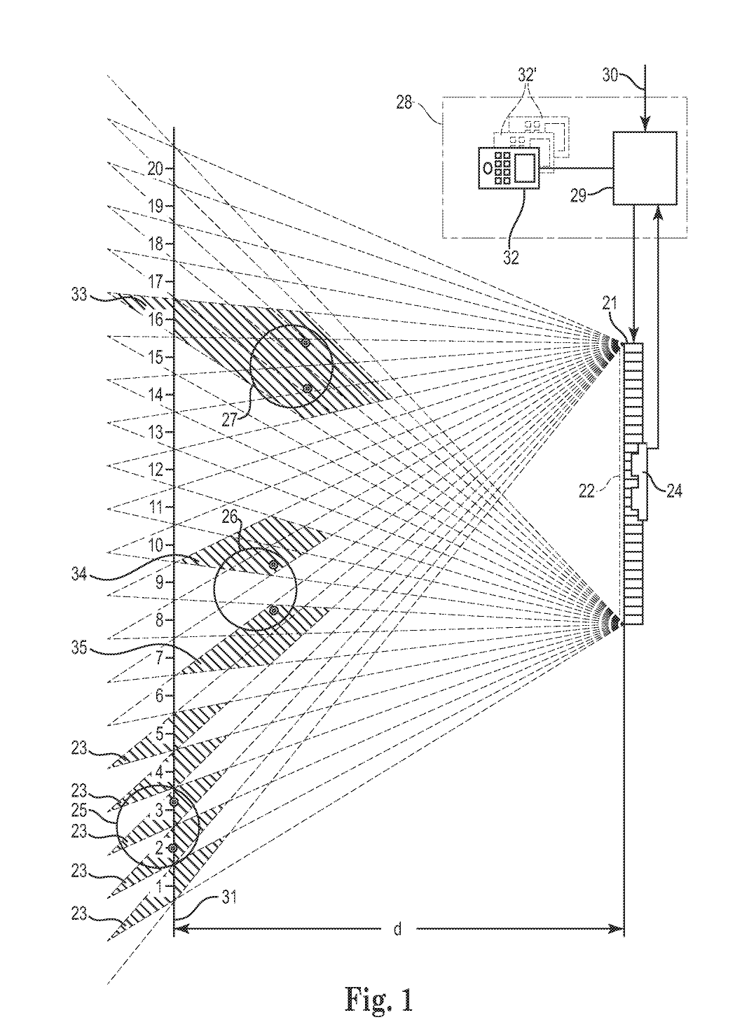

An image display device is therefore shown in FIG. 1 which is realized while using an autostereoscopic screen. This screen has a matrix screen 21 having a plurality of pixels arranged in rows and columns and has a grating 22 arranged in front of the matrix screen 21 which is suitable to direct light emanating from the pixels of the matrix screen 21 in each case into a different one of a plurality of laterally offset viewing zones 23. These viewing zones 23 are numbered consecutively here and correspond to twenty image channels 1 to 20 of the screen. The grating 22 can also be called a beam splitter grating or a barrier grating. On a finer division of the matrix screen, a much larger number of possible image channels can naturally also be provided.

The matrix screen 21 is a liquid crystal screen. The pixels of this matrix screen 21 are subpixels of three different basic colors, with in each case red, green and blue subpixels alternating in a cyclic order in each row and in each column. In some embodiments, an OLED display could instead be used. Each picture element displayed on the matrix screen 21 is formed by a pixel group or a cluster of a plurality of subpixels and extends over three rows so that any desired color can be displayed in its true color independently of a width of the picture element or of the pixel group or of the cluster.

The grating 22 can e.g. be designed as a slit grating or as a cylindrical lens grating, with slits or cylindrical lenses of the grating 22—assuming a corresponding arrangement of the columns—being able to be orientated vertically or also inclined from a vertical by approximately 20 degrees. In every case, a structure of the grating 22 is orientated parallel to the columns.

In addition to the actual autostereoscopic screen having the matrix screen 21 and the grating 22, the image display device has a tracking device 24 for detecting two respective eye positions of, in the present case, a first viewer 25 of the screen, a second viewer 26 of the screen and a third viewer 27 of the screen. In some embodiments, the tracking unit 24 is a stereoscopic image camera having two lenses which is configured for automatic image evaluation. It is not significant in this respect whether the image evaluation allows the eye positions to be recognized directly or whether first only head positions are detected and the eye positions are determined in dependence on the head positions using a typical eye spacing of approx. 65 mm as the basis.

Finally, the image display device has a control unit 28 which includes a data processing system 29 and is configured from a technical programming aspect to control the matrix screen 21. For this purpose, the control unit 28 can control the pixels of the matrix screen 21 in dependence on image information 30 of different images, in particular in dependence on image information of different stereoscopic half-images. The image information 30 can for this purpose be read out of a data store—e.g. from a DVD or from other data carriers—or can be output by a TV receiver or by a games console for video games.

In an operating mode which is not the focus of interest in the present case, the screen can be operated as a conventional multiview screen (multiview display) in that image information of twenty mutually complementary stereoscopic half-images are displayed on the pixels of the matrix screen 21 in cyclic order so that a respective one of these stereoscopic half-images is visible from each of the laterally offset viewing zones 23. In a plane 31 which is remote from the matrix screen 21 by a nominal viewing distance d and in which the viewing zones 23 can have a maximum width (typically a width of approximately a mean eye spacing of 65 mm or a little less), a plurality of persons can then simultaneously perceive stereoscopic images of the same scene autostereoscopically.

A different method of displaying images using the image display device will be described here. To carry this out, the control unit 28 also has, in addition to the data processing system 29, an operating device 32 for inputting input commands which define in each case one of different image contents and one of different possible display modes for the viewers 25, 26 and 27 as well as under certain circumstances also for further viewers independently. Corresponding further operating devices 32′ can naturally also be provided in addition to the operating device 32 so that each of the viewers 25, 26, 27 can input the input commands relative to him to his own operating device 32 or 32′. The statements only given for the operating device 32 in the following then also apply accordingly to the further operating devices 32′.

These selectable display modes in particular include a monoscopic image mode, an individual stereoscopic image mode and a multiview stereoscopic image mode. The operating device 32 can be connected to the data processing system 29 of the control unit 28 via a cable connection or by a wireless data transfer. The image contents can each e.g. be defined by a TV channel, a video channel or a video game.

Let it be assumed, for example, that in a shown situation the first viewer 25 has selected the multiview stereoscopic image mode, the second viewer 26 has selected the individual stereoscopic image mode and the third viewer 27 has selected the monoscopic image mode and have input corresponding input commands into the operating device 32.

The control unit 28 is now configured from a technical program aspect to control the matrix screen 21 in the manner described in the following not only in dependence on the image information 30, but also in dependence on these input commands and on the eye positions detected by the tracking device 24.

First, different disjunctive excerpts of columns of the matrix screen 21 are defined such that one of the excerpts is associated with each of the detected eye positions of each of the viewers 25, 26 and 27, said one excerpt including at least all columns of the matrix screen 21 visible from this eye position through the grating 22. In this respect, a single excerpt which includes all columns which are visible from both eye positions of this viewer is defined for every viewer for whom the monoscopic image mode is selected as the display mode. In the present case, this is the case for the third viewer 27. An image displayed on this excerpt is visible from a region 33 in which both eye positions of the viewer 27 are located.

Two different excerpts are in contrast associated with the two eye positions of each viewer for whom the individual stereo image mode is selected as the display mode, that is, one excerpt with a left eye position and one excerpt with a right eye position. This applies here to the second viewer 26. An image which is displayed on the excerpt which is associated with the left eye position of the viewer 26 is visible from a region 34, whereas an image displayed on the other excerpt is visible from a region 35 which is laterally offset with respect to the region 34.

A common excerpt is again associated with the two eye positions of each viewer for whom the multiview stereo image mode is selected as the display mode. This applies here to the first viewer 25. Like the other excerpts, this excerpt also comprises a family of strips which each include a plurality of columns and which alternate with the strips of the other excerpts from left to right over the matrix screen 21 in a cyclic order. The excerpt which is associated with the eye positions of the viewer 25 is moreover broken down into a plurality of subgroups, five in the present case, wherein these subgroups each include exactly one column from each of the named strips of this excerpt. An image which is displayed on one of these subgroups can then be seen from exactly one of the five viewing positions 23 drawn as hatched in FIG. 1.

Now in each case at least one of different images is displayed on each of the excerpts, wherein the pixels of each excerpt are controlled so that the at least one image displayed on this excerpt shows the image content which is defined for the viewer 25, 26 or 27 by the input commands input into the operating device 32. The images will naturally typically be moving images.

In this respect, exactly one image, namely a monoscopic image which can be seen from the viewer 27, is displayed on the excerpt which is associated with the eye positions of the third viewer 27. The same applies accordingly to other viewers if they select the monoscopic image mode by a corresponding input into the operating device

Two mutually complementary stereoscopic half-images are displayed on the two excerpts which are associated with the second viewer 26 so that a left half-image is visible from the region 34 and a right half-image is visible from the region 35 and the viewer 26 can see a stereoscopic image which these half-images combine to form. The same applies accordingly to other viewers if they select the individual stereoscopic image mode by a corresponding input into the operating device 32.

A whole family of mutually complementary half-images, five in the present case, is displayed on the excerpt which is associated with the first viewer 25 or with any other viewer who has selected the multiview stereoscopic image mode and for whom a corresponding input has been made into the operating device 32, and indeed on each of the named sub-groups one each so that the viewer 25 sees a stereoscopic image, and indeed from a perspective which depends on where exactly his eye positions are located.

If the image information 30 does not include all control data for the matrix screen 21 which is required for displaying the stereoscopic half-images for the viewer 25, these control data can also be calculated by rendering by the data processing system 29 from a lower quantity of image data which are present for the corresponding image content.

The tracking device 24 can naturally also detect a movement of the eye positions, whereas the control unit is configured then to redefine the excerpts in dependence on the detected movement.

The operating device 32 also has, in addition to operating elements such as in particular keys, an output unit 36 in the form of a display on which the information on the available image contents and on the display modes selectable for the respective image content can be displayed. In addition, it can be displayed on the output unit 36 whether a last input command can be executed. The input commands are in this respect typically input successively for the different viewers 25, 26 and 27 and, optionally, for further viewers as registrations of these viewers. The control unit 28 is in this respect also configured to determine and to display on the output unit 36 in dependence on already carried out registrations and on the detected eye positions of the corresponding viewers 25, 26 or 27 whether a further viewer can be registered (this could be precluded if there is no more room for further required excerpts on the matrix screen 21) and if so whether and optionally how a positioning of already registered views 25, 26 or 27 or of the viewer who wants to register has to be changed so that a further registration is possible or so that a last input input command can be executed.

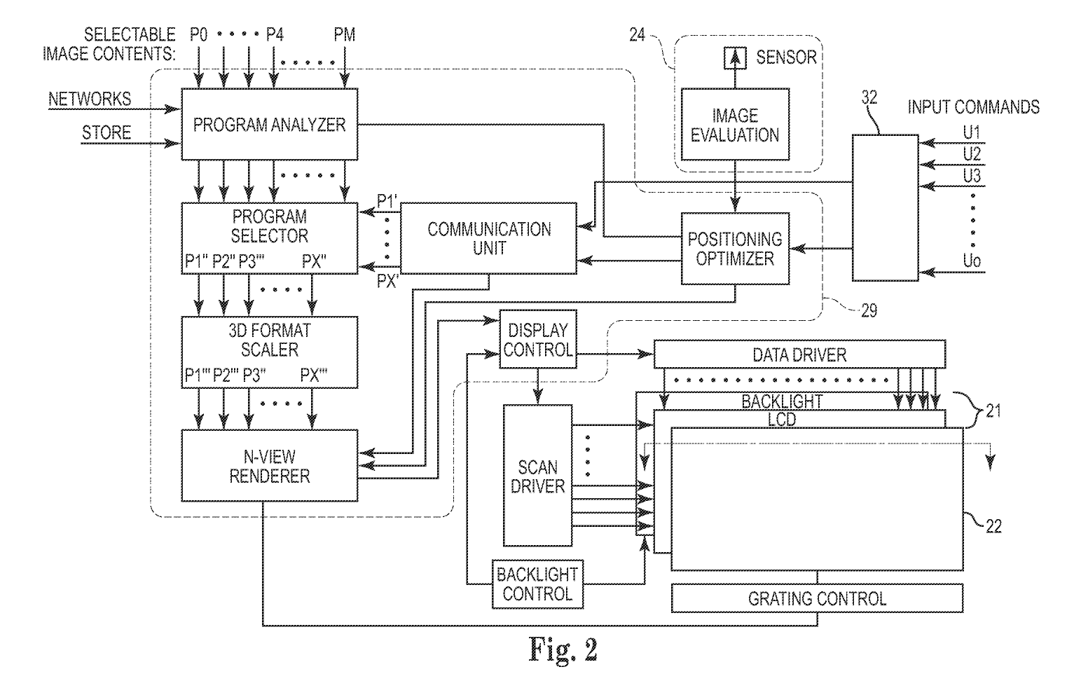

In FIG. 2, a possible architecture of the image display device and in particular of the control unit 28 is illustrated. Repeating features are in this respect again provided with the same reference numerals.

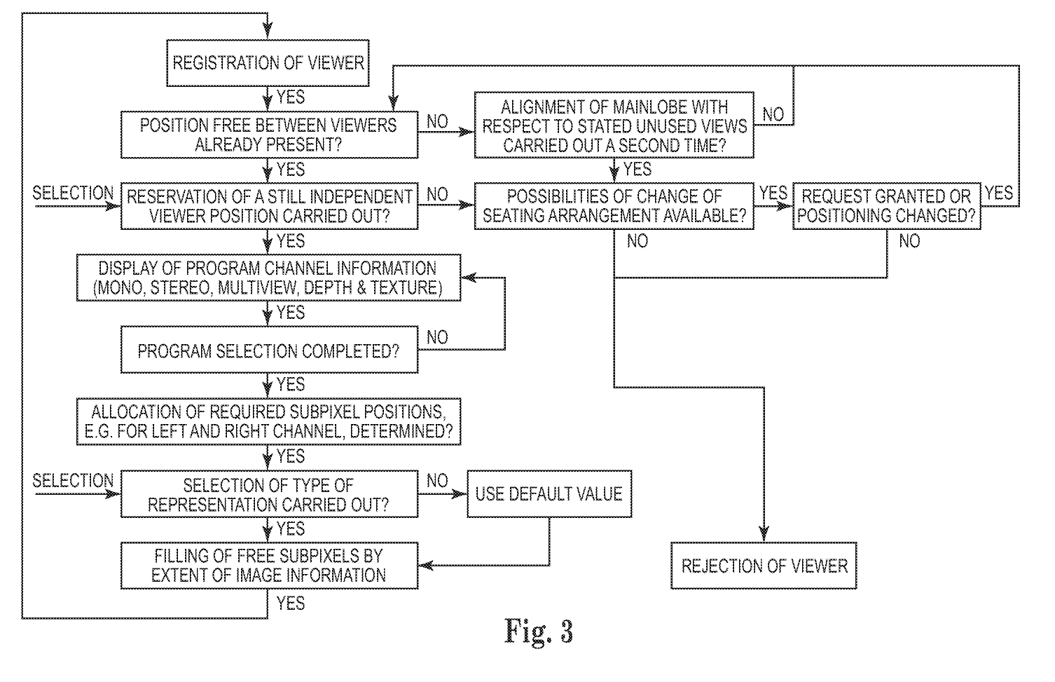

FIG. 3 in turn describes which steps are carried out by the control unit 28—in dependence on any registrations already made—when one of the viewers 25, 26, 27 registers by inputting input commands into the operating device 32. In this respect, in particular the function of the positioning optimizer shown in FIG. 2 is described which checks whether one or more of the viewers 25, 26 or 27 have to be repositioned so that the current registration can be carried out. The selected display mode is here called a representation kind. The term “main lobe” designates the region in which the two fields of rays intersect which are drawn in FIG. 1 and there emanate from two picture elements disposed at the very outside. This region can be displaced to the right or to the left by reallocation of image channels, which brings about an ever greater flexibility. Zones occur outside this region from which again the same images are visible as in the viewing zones 23 and the regions 33, 34 and 35.

We claim:

1. An image display device, comprising:
an autostereoscopic screen for simultaneously displaying a plurality of different images which are visible in each case from at least one of different laterally offset viewing zones;
a tracking device for detecting two respective eye positions of at least two viewers of the screen; and
a control unit for controlling the screen in dependence on image information of the different images;
wherein the screen has a matrix screen having a plurality of pixels arranged in columns and rows as well as a grating arranged in front of the matrix screen and having a structure orientated parallel to the columns to direct light emanating from the pixels of the matrix screen into the different viewing zones,
wherein the control unit is configured to input inputted commands which define in each case one of different possible image contents and one of different selectable display modes for at least two different viewers independently, wherein the selectable display modes include a monoscopic mode and an individual stereoscopic image mode;
and the control unit is configured to control the screen in dependence on these input commands and on the eye positions detected by the tracking device by defining different disjunctive excerpts of columns of the matrix screen and displaying in each case at least one of different images on each of the excerpts such that
one of the excerpts is associated with each of the detected eye positions of each viewer, said one excerpt including at least all columns of the matrix screen visible from these eye position through the grating,
wherein the pixels of this excerpt are controlled so that the at least one image displayed on this excerpt shows the image content defined for this viewer,
wherein
a) the same excerpt is associated with the two eye positions of each viewer for whom the monoscopic image mode is selected as the display mode and the image displayed on said excerpt is a monoscopic image, whereas
b) two different excerpts are associated with the two eye positions of each viewer for whom the individual stereoscopic image mode is selected as the display mode and two mutually complementary stereoscopic half-images are displayed on these excerpts.

2. An image display device in accordance with claim 1, wherein the selectable display modes furthermore include a multiview stereoscopic image mode and the control unit is configured to control the screen so that the same excerpt is associated with the two eye positions of each viewer for whom the multiview stereoscopic image mode is selected as the display mode and in each case one of a family of complementary stereoscopic half-images is displayed on different subsets of columns of this except.

3. An image display device in accordance with claim 2, wherein the control unit includes a renderer which is configured to calculate control data for the matrix screen required for the representation of the family of stereoscopic half-images from image information on the image content which is defined by the input commands for the viewer for whom the multiview stereoscopic image mode is selected as the display mode.

4. An image display device in accordance with claim 1, wherein the tracking device is configured to detect a movement of the eye positions and the control unit is configured to redefine the excerpts in dependence on the detected movement.

5. An image display device in accordance with claim 1, wherein the control unit is configured to accept the input commands for the at least two viewers successively as registrations of the viewers.

6. An image display device in accordance with claim 1, wherein the control unit has an output unit for displaying information on one or more of the available image contents, the display modes selectable for the respective image content and on whether a last input command can be executed.

7. An image display device in accordance with claim 6, wherein that the control unit is configured to determine and to display on the output unit in dependence on already inputted input commands and on the detected eye positions whether a further viewer can be registered and/or whether or how a positioning of already registered viewers has to be changed so that a further viewer can be registered or a last inputted input command can be executed.

8. A method of displaying images comprising:
inputting commands into a control unit that define in each case one of different possible image contents and one of different selectable display modes for at least two different viewers independently, wherein the selectable display modes include a monoscopic image mode and an individual stereoscopic image mode;
detecting two respective eye positions of at least two viewers; and
controlling a matrix screen having a plurality of pixels arranged in different columns via the control unit in dependence on the input commands and on the eye positions detected by the tracking device as well as in dependence on image information of different images defined by the image contents so that the images are displayed simultaneously on different subgroups of pixels of the matrix screen, wherein light emanating from the pixels is directed by a grating arranged in front of the matrix screen into different laterally offset regions from which one of the respective images is visible,
wherein different disjunctive excerpts of columns of the matrix screen are defined by the control unit and in each case at least one of the different images is displayed on each of the excerpts such that one of the excerpts is associated with each of the detected eye positions of each viewer, said one excerpt including at least all columns of the matrix screen visible from this eye position through the grating,
wherein the pixels of this excerpt are controlled so that the at least one image displayed on this excerpt shows the image content defined for this viewer, wherein
a) the same excerpt is associated with the two eye positions of each viewer for whom the monoscopic image mode is selected as the display mode and a monoscopic image is displayed on this excerpt, whereas
b) two different excerpts are associated with the two eye positions of each viewer for whom the individual stereoscopic image mode is selected as the display mode and two mutually complementary stereoscopic half-images are displayed on these excerpts.

9. A method in accordance with claim 8, wherein the selectable display modes include a multiview stereoscopic image mode, wherein the matrix screen is controlled so that in each case the same excerpt is associated with the two eye positions of each viewer for whom the multiview stereoscopic image mode is selected as the display mode and in each case one of a family of complementary stereoscopic half-images is displayed on different subsets of columns of this except.

10. A method in accordance with claim 9, wherein control data for representing the family of stereoscopic half-images are calculated by rendering from image information on the image content which is defined by the input commands for the viewer for whom the multiview stereoscopic image mode is selected as the display mode, with the pixels of the excerpt which is associated with the eye positions of this viewer being controlled in dependence on these control data.

11. A method in accordance with claim 8, wherein a movement of the eye positions is detected and the excerpts are redefined in dependence on the detected movement.
